(19) United States
(12) Patent Application Publication
(10) Pub. No.: US 2024/0345764 A1
(43) Pub. Date: Oct. 17, 2024

(54) MEMORY CONTROL CIRCUIT UNIT, MEMORY STORAGE DEVICE AND PARAMETER UPDATING METHOD

(71) Applicant: PHISON ELECTRONICS CORP., Miaoli (TW)

(72) Inventors: Wei-Cheng Li, Miaoli County (TW); Ping-Cheng Chen, Taoyuan City (TW); Yu-Chung Shen, Miaoli County (TW); Jia-Li Xu, New Taipei City (TW)

(73) Assignee: PHISON ELECTRONICS CORP., Miaoli (TW)

(21) Appl. No.: 18/332,771

(22) Filed: Jun. 12, 2023

(30) Foreign Application Priority Data
Apr. 14, 2023 (TW) 112114137

(51) Int. Cl. G06F 3/06

(52) U.S. Cl. CPC G06F 3/0655; G06F 3/0604; G06F 3/0679

(57) ABSTRACT

A memory control circuit unit, a memory storage device, and a parameter updating method are disclosed. The memory control circuit unit includes a host interface, a memory interface, and a memory management circuit. The memory interface is configured to be coupled to a rewritable non-volatile memory module. The memory management circuit is configured to detect system status and activate an interface parameter updating operation in response to the system status meeting a target condition. The memory management circuit is further configured to update at least one interface parameter used by at least one of the memory interface and the rewritable non-volatile memory module during the interface parameter updating operation.

### CROSS-REFERENCE TO RELATED APPLICATION

This application claims the priority benefit of Taiwanese application no. 112114137, filed on Apr. 14, 2023. The entirety of the above-mentioned patent application is hereby incorporated by reference herein and made a part of this specification.

### BACKGROUND

### Technical Field

The disclosure relates to memory management technology. In particular, the disclosure relates to a memory control circuit unit, a memory storage device, and a parameter updating method.

### Description of Related Art

Rapid growth of portable electronic devices such as mobile phones and notebook computers in these years causes a rapid increase in consumers' demand for storage media. Due to characteristics of non-volatile data, power saving, small size, and non-mechanical structure, a rewritable non-volatile memory module (e.g., flash memory) is relatively suitable to be built in various portable electronic devices exemplarily mentioned above.

Generally speaking, before a memory storage device or a memory controller leaves the factory, operating parameters of a memory interface in the memory storage device or the memory controller for accessing the rewritable non-volatile memory module have already been set. After the memory storage device or the memory controller leaves the factory, the memory interface of the memory storage device or the memory controller may automatically operate according to the preset operating parameters to access the rewritable non-volatile memory module. However, in practice, operating according to the preset operating parameters may in some cases lead to a decline in sampling quality of data transmitted between the memory interface and the rewritable non-volatile memory module.

### SUMMARY

The disclosure provides a memory control circuit unit, a memory storage device, and a parameter updating method, in which sampling quality of data transmitted between a memory interface and a rewritable non-volatile memory module may be maintained or even improved maximally during operation of a device.

An exemplary embodiment of the disclosure provides a memory control circuit unit configured to control a rewritable non-volatile memory module. The memory control circuit unit includes a host interface, a memory interface, and a memory management circuit. The host interface is configured to be coupled to a host system. The memory interface is configured to be coupled to the rewritable non-volatile memory module. The memory management circuit is coupled to the host interface and the memory interface. The memory management circuit is configured to: detect system status; activate an interface parameter updating operation in response to the system status meeting a target condition; and update at least one interface parameter used by at least one of the memory interface and the rewritable non-volatile memory module during the interface parameter updating operation. The at least one interface parameter affects sampling quality of data transmitted between the memory interface and the rewritable non-volatile memory module.

An exemplary embodiment of the disclosure further provides a memory storage device including a rewritable non-volatile memory module and a memory control circuit unit. The memory control circuit unit is coupled to the rewritable non-volatile memory module. The memory control circuit unit is configured to: detect system status; activate an interface parameter updating operation in response to the system status meeting a target condition; and update at least one interface parameter used by at least one of the memory control circuit unit and the rewritable non-volatile memory module during the interface parameter updating operation. The at least one interface parameter affects sampling quality of data transmitted between the memory control circuit unit and the rewritable non-volatile memory module.

An exemplary embodiment of the disclosure further provides a parameter updating method for a memory control circuit unit. The memory control circuit unit is configured to control a rewritable non-volatile memory module. The parameter updating method includes the following. System status is detected. An interface parameter updating operation is activated in response to the system status meeting a target condition. At least one interface parameter used by at least one of the memory control circuit unit and the rewritable non-volatile memory module is updated during the interface parameter updating operation. The at least one interface parameter affects sampling quality of data transmitted between the memory control circuit unit and the rewritable non-volatile memory module.

Based on the foregoing, after the system status is detected, the interface parameter updating operation may be activated if the system status meets the target condition. The interface parameter used by at least one of the memory interface and the rewritable non-volatile memory module may be updated during the interface parameter updating operation. In particular, the interface parameter may affect the sampling quality of data transmitted between the memory interface and the rewritable non-volatile memory module. Accordingly, regardless of the changes in the system status, the sampling quality of data transmitted between the memory interface and the rewritable non-volatile memory module may be maintained or even improved as much as possible.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a memory storage device according to an exemplary embodiment of the disclosure.

FIG. 2 is a schematic diagram of read DQ training and write DQ training according to an exemplary embodiment of the disclosure.

FIG. 3 is a schematic diagram of a read scan window correction and a write scan window correction according to an exemplary embodiment of the disclosure.

FIG. 4 is a flowchart of a parameter updating method according to an exemplary embodiment of the disclosure.

FIG. 5 is a flowchart of a parameter updating method according to an exemplary embodiment of the disclosure.

### DESCRIPTION OF THE EMBODIMENTS

Several exemplary embodiments are provided below to describe the disclosure, but the disclosure is not limited to the presented exemplary embodiments. Appropriate combinations between the exemplary embodiments are also allowed. The term “coupling” used throughout this specification (including the appended claims) may refer to any direct or indirect means of connection. For example, if it is herein described that a first device is coupled to a second device, it should be interpreted that the first device may be directly connected to the second device, or the first device may be indirectly connected to the second device through another device or some connection means. In addition, the term “signal” may refer to at least one current, voltage, charge, temperature, data, or any other signal or other signals.

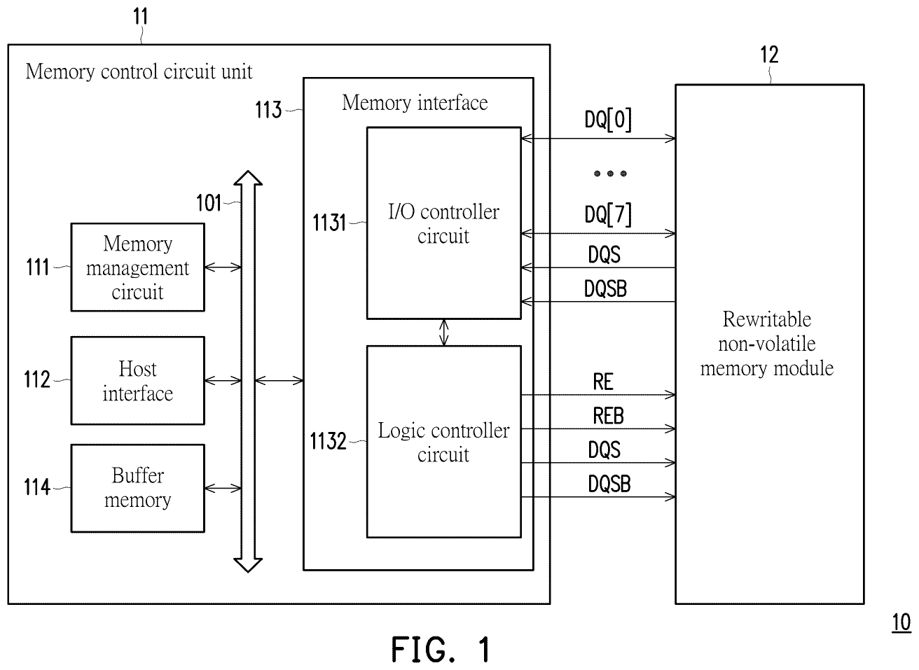

FIG. 1 is a schematic diagram of a memory storage device according to an exemplary embodiment of the disclosure.

With reference to FIG. 1, a memory storage device 10 may include a memory control circuit unit 11 and a rewritable non-volatile memory module 12. The memory control circuit unit 11 is coupled to the rewritable non-volatile memory module 12. The memory control circuit unit 11 may be configured to control and access the rewritable non-volatile memory module 12. For example, the memory control circuit unit 11 may be configured to write data into the rewritable non-volatile memory module 12, read data from the rewritable non-volatile memory module 12, or erase data from the rewritable non-volatile memory module 12. In an exemplary embodiment, the memory control circuit unit 11 may include a flash memory controller or a memory control chip.

The rewritable non-volatile memory module 12 is configured to store the data written by the memory control circuit unit 11 (or a host system). The rewritable non-volatile memory module 12 may include a single level cell (SLC) NAND flash memory module (i.e., a flash memory module that may store 1 bit in one memory cell), a multi level cell (MLC) NAND flash memory module (i.e., a flash memory module that may store 2 bits in one memory cell), a triple level cell (TLC) NAND flash memory module (i.e., a flash memory module that may store 3 bits in one memory cell), a quad level cell (QLC) NAND flash memory module (i.e., a flash memory module that may store 4 bits in one memory cell), other flash memory modules, or other memory modules with the same or similar characteristics.

Each memory cell in the rewritable non-volatile memory module 12 stores one or more bits by changes in the voltage (also referred to as a threshold voltage hereinafter). Specifically, there is a charge trapping layer between the control gate and the channel of each memory cell. By applying a write voltage to the control gate, the amount of electrons in the charge trapping layer may be changed, changing the threshold voltage of the memory cell. This operation of changing the threshold voltage of the memory cell is also referred to as “writing data into the memory cell” or “programming the memory cell”. As the threshold voltage changes, each memory cell in the rewritable non-volatile memory module 12 has multiple storage states. By applying a read voltage, it is possible to determine which storage state one memory cell belongs to, and accordingly obtain the one or more bits stored in the memory cell. The use of the rewritable non-volatile memory module 12 belongs to the conventional technology, and is thus not repeatedly described here.

The memory control circuit unit 11 includes a memory management circuit 111, a host interface 112, a memory interface 113, and a buffer memory 114. The memory management circuit 111, the host interface 112, the memory interface 113, and the buffer memory 114 may communicate or transfer signals with each other through a bus 101.

The memory management circuit 111 is configured to be responsible for the overall or partial operation of the memory control circuit unit 11. For example, the memory management circuit 111 may include a central processing unit (CPU), a programmable general-purpose or special-purpose microprocessor, a digital signal processor (DSP), a programmable controller, an application specific integrated circuit (ASIC), a programmable logic device (PLD), or other similar devices or a combination of these devices.

The host interface 112 is configured to be coupled to a host system. The memory control circuit unit 11 may communicate with the host system through the host interface 112. The host interface 112 may be configured to receive and identify commands and data sent by the host system. For example, the commands and data sent by the host system may be sent to the memory control circuit unit 11 through the host interface 112. In addition, the memory control circuit unit 11 may send data to the host system through the host interface 112. For example, the host interface 112 may be compatible with the peripheral component interconnect express (PCI Express) standard, serial advanced technology attachment (SATA) standard, parallel advanced technology attachment (PATA) standard, institute of electrical and electronic engineers (IEEE) 1394 standard, universal serial bus (USB) standard, SD interface standard, ultra high speed-I (UHS-I) interface standard, ultra high speed-II (UHS-II) interface standard, memory stick (MS) interface standard, MCP interface standard, MMC interface standard, eMMC interface standard, universal flash storage (UFS) interface standard, eMCP interface standard, CF interface standard, integrated device electronics (IDE) standard, or other suitable standards.

The memory interface 113 is configured to be coupled to the rewritable non-volatile memory module 12. The memory control circuit unit 11 may access the rewritable non-volatile memory module 12 through the memory interface 113. For example, the memory control circuit unit 11 may write, read, or erase data on the rewritable non-volatile memory module 12 through the memory interface 113. For example, if the memory control circuit unit 11 is to access the rewritable non-volatile memory module 12, the memory interface 113 may send the corresponding command sequence to the rewritable non-volatile memory module 12. For example, these command sequences may include a write command sequence commanding writing data, a read command sequence commanding reading data, an erase command sequence commanding erasing data, and corresponding command sequences for commanding various memory operations (e.g., changing a read voltage level or performing a garbage collection operation). The command sequences are, for example, generated by the memory management circuit 111 or other management circuits and sent to the rewritable non-volatile memory module 12 through the memory interface 113. The command sequences may include one or more signals, or data on the bus. The signals or data may include a command code or a programming code. For example, the read command sequence may include an identification code, a memory address, or other information that is read.

The buffer memory 114 is configured to temporarily store data. For example, the buffer memory 114 may include static random access memory (SRAM), dynamic random access memory (DRAM), or other forms of buffer memory.

In an exemplary embodiment, the memory control circuit unit 11 may further include read only memory (ROM), an error checking and correction circuit, and a power management circuit. The read-only memory may be configured to store management data such as firmware (e.g., a boot code) of the memory control circuit unit 11. The error checking and correction circuit may be configured to encode and decode data. The power management circuit may be configured to manage the power of the memory control circuit unit 11. In addition, more useful circuits may be added to the memory control circuit unit 11, which is not limited by the disclosure.

In an exemplary embodiment, the memory interface 113 includes an input/output controller (I/O controller) circuit 1131 and a logic controller circuit 1132. The I/O controller circuit 1131 is configured to control transmission or sampling of data signals. The logic controller circuit 1132 is coupled to the I/O controller circuit 1131 and configured to control transmission or sampling of command signals.

Taking reading data from the rewritable non-volatile memory module 12 as an example, the I/O controller circuit 1131 may receive a DQ signal, a DQS signal, and a DQSB signal from the rewritable non-volatile memory module 12. The DQ signal carries data read from the rewritable non-volatile memory module 12. For example, assuming that the memory interface 113 has 8 DQ pins, the DQ signal may include DQ[0] to DQ[7]. Nonetheless, the disclosure does not limit the total number of DQ pins in the memory interface 113. The DQS signal corresponds to the DQ signal and may reflect a clock (e.g., a clock frequency) of the DQ signal. As a result, the I/O controller circuit 1131 may obtain the clock of the DQ signal according to the DQS signal and sample the DQ signal according to the clock. By sampling the DQ signal, the data bits carried by the DQ signal may be obtained. In addition, the DQSB signal is inverted to the DQS signal.

In addition, the logic controller circuit 1132 may transmit a RE signal, a REB signal, a DQS signal, and a DQSB signal to the rewritable non-volatile memory module 12. The RE signal may serve to indicate that relevant data of the read command is located on the DQ pins of the I/O controller circuit 1131. The REB signal is inverted to the RE signal, and the DQSB signal is inverted to the DQS signal. It should be noted that those skilled in the art should know the relevant technical details about how to access the rewritable non-volatile memory module 12 through the memory interface 113, which is thus not repeatedly described here.

It should be noted that, as system status of the memory storage device 10 changes, sampling quality of data transmitted between the memory interface 113 and the rewritable non-volatile memory module 12 may decline. The reason is that, after the system status of the memory storage device 10 changes, some parameters preset in the memory interface 113 and the rewritable non-volatile memory module 12 to process the transmitted signals (e.g., the DQ signal, the DQS signal, and the RE signal) may not be the optimal parameters under the current system status.

In an exemplary embodiment, the memory management circuit 111 may dynamically update at least one parameter (also referred to as an interface parameter) used by at least one of the memory interface 113 and the rewritable non-volatile memory module 12 according to the change in the system status of the memory storage device 10, addressing to the above issue.

In an exemplary embodiment, the memory management circuit 111 may detect the current system status of the memory storage device 10. For example, the system status is related to the current operating status of the memory control circuit unit 11, the rewritable non-volatile memory module 12, and/or the memory storage device 10.

The memory management circuit 111 may determine whether the current system status of the memory storage device 10 meets a specific condition (also referred to as a target condition). If (or in response to that) the system status meets the target condition, the memory management circuit 111 may activate an interface parameter updating operation. The memory management circuit 111 may update at least one interface parameter used by at least one of the memory interface 113 and the rewritable non-volatile memory module 12 during the interface parameter updating operation. In particular, the interface parameter may affect the sampling quality of data transmitted between the memory interface 113 and the rewritable non-volatile memory module 12. Nonetheless, if (or in response to that) the system status does not meet the target condition, the memory management circuit 111 may not activate the interface parameter updating operation.

In an exemplary embodiment, the system status may reflect error status of data read from the rewritable non-volatile memory module 12. For example, the error status may reflect a bit error rate (BER) of the data read from the rewritable non-volatile memory module 12, the total number of error bits included in the data, and/or whether the data includes an uncorrectable error. In an exemplary embodiment, after data is read from the rewritable non-volatile memory module 12, the error checking and correction circuit may decode the data. The memory management circuit 111 may obtain the error status of the data according to the decoding result of the data.

In an exemplary embodiment, the system status may reflect clock status of the memory control circuit unit 11. For example, the clock status may reflect a current clock frequency of the memory control circuit unit 11.

In an exemplary embodiment, the system status may reflect current system temperature status. For example, the system temperature status may reflect current temperature (also referred to as system temperature) of the memory control circuit unit 11, the rewritable non-volatile memory module 12, and/or the memory storage device 10.

In an exemplary embodiment, the system status may reflect data storage status of the rewritable non-volatile memory module 12. For example, the data storage status may reflect a current data storage amount of the rewritable non-volatile memory module 12. In an exemplary embodiment, the system status may reflect at least one of the above-mentioned multiple states.

In an exemplary embodiment, in response to the bit error rate of the data read from the rewritable non-volatile memory module 12 exceeding a threshold (also referred to as a first threshold), the total number of error bits included in the data read from the rewritable non-volatile memory module 12 exceeding a threshold (also known as a second threshold), the data read from the rewritable non-volatile memory module 12 including an uncorrectable error, the clock frequency of the memory control circuit unit 11 changing, the system temperature changing, and/or the data storage amount of the rewritable non-volatile memory module 12 reaching a threshold (also known as a third threshold), the memory management circuit 111 may determine that the current system status of the memory storage device 10 meets the target condition. Comparatively, the memory management circuit 111 may determine that the current system status of the memory storage device 10 does not meet the target condition.

In an exemplary embodiment, whenever the current system status of the memory storage device 10 meet one target condition, the memory management circuit 111 may correspondingly activate one interface parameter updating operation in an attempt to update the interface parameter used by the memory interface 113 and/or the rewritable non-volatile memory module 12. By updating the interface parameter, the sampling quality of data transmitted between the memory interface 113 and the rewritable non-volatile memory module 12 may be improved or optimized. In an exemplary embodiment, the adopted decision bases, such as the first threshold, the second threshold, and/or the third threshold, corresponding to different target conditions may be different.

In an exemplary embodiment, by improving or optimizing the sampling quality of data transmitted between the memory interface 113 and the rewritable non-volatile memory module 12, correctness of the data read from the rewritable non-volatile memory module 12 may be improved. In addition, by improving the correctness of the data read from the rewritable non-volatile memory module 12, it is possible to reduce the bit error rate of the data read from the rewritable non-volatile memory module 12, reduce the total number of error bits included in the data read from the rewritable non-volatile memory module 12, and/or increase the success rate of decoding the data read from the rewritable non-volatile memory module 12. Accordingly, the overall operation efficiency of the memory storage device 10 may be improved.

In an exemplary embodiment, the updated interface parameter may affect at least one of a delay amount of the DQ signal (e.g., DQ[0] to DQ[7]), a delay amount of the DQS signal, a read window size of the DQ signal, and a write window size of the DQ signal. In an exemplary embodiment, by updating the interface parameter to change (e.g., optimize) the delay amount of the DQ signal (e.g., DQ[0] to DQ[7]), the delay amount of the DQS signal, the read window size of the DQ signal, and/or the write window size of the DQ signal, the sampling quality of data transmitted between the memory interface 113 and the rewritable non-volatile memory module 12 may be improved or optimized.

In an exemplary embodiment, after activating the interface parameter updating operation, the memory management circuit 111 may determine whether at least one interface parameter corresponding to the target condition (also referred to as a first interface parameter) has been stored in system information. For example, the system information may be stored in the system region of the rewritable non-volatile memory module 12 to prevent modification by the user.

If (or in response to that) the first interface parameter corresponding to the target condition has been stored in the system information, the memory management circuit 111 may update the interface parameter by directly using the first interface parameter. Nonetheless, if (or in response to that) the first interface parameter corresponding to the target condition is not stored in the system information, the memory management circuit 111 may perform a scan window correction between the memory interface 113 and the rewritable non-volatile memory module 12. Then, the memory management circuit 111 may update the interface parameter by using a corresponding interface parameter (also referred to as a second interface parameter) according to a performance result (also referred to as a correction result) of the scan window correction. In addition, the memory management circuit 111 may record the second interface parameter in the system information and bind the second interface parameter to the target condition.

In other words, in an exemplary embodiment, if the first interface parameter corresponding to the target condition has been stored in the system information, the interface parameter may be updated by directly using the first interface parameter, and the scan window correction may be omitted. Accordingly, interface parameter update efficiency may be improved. Nonetheless, if the first interface parameter corresponding to the target condition is not stored in the system information, the memory management circuit 111 needs to re-evaluate the optimal value (i.e., the second interface parameter) of the interface parameter through the scan window correction, to update the interface parameter according to the optimal value (i.e., the second interface parameter).

In an exemplary embodiment, the memory management circuit 111 may also perform the scan window correction and update the interface parameter by using the second interface parameter after each time of activating the interface parameter updating operation, which is not limited by the disclosure. In addition, the updated interface parameter may be written into the memory interface 113 or the rewritable non-volatile memory module 12. After that, the memory interface 113 or the rewritable non-volatile memory module 12 may automatically operate according to the updated interface parameter.

In an exemplary embodiment, the scan window correction includes at least one of a duty cycle correction, read DQ training, write DQ training, a read scan window correction, and a write scan window correction.

During the duty cycle correction, the duty cycle error between the RE signal and the REB signal may be re-corrected. During the read DQ training and the write DQ training, the memory management circuit 111 may send a specific command sequence to the rewritable non-volatile memory module 12 to command the rewritable non-volatile memory module 12 to perform correction on DQ signals (i.e., DQ[0] to DQ[7]) on multiple DQ pins.

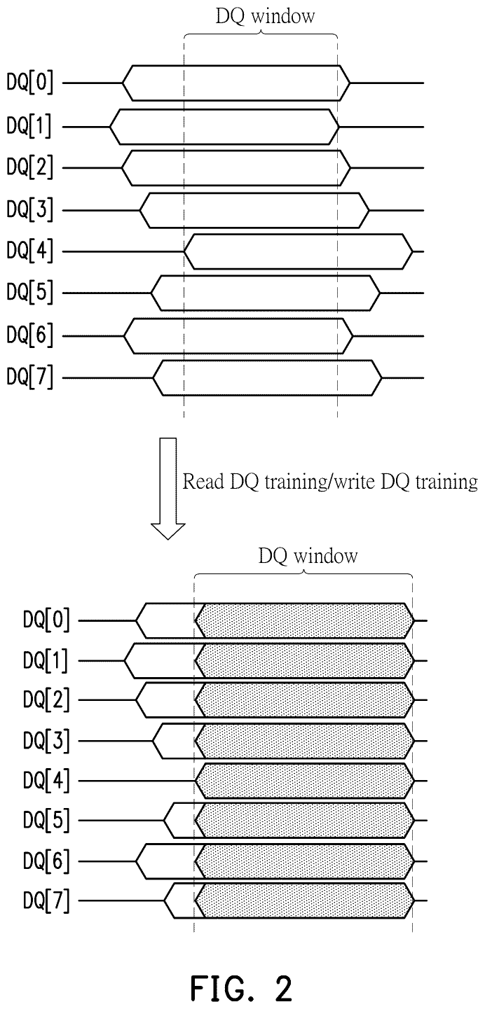

FIG. 2 is a schematic diagram of read DQ training and write DQ training according to an exemplary embodiment of the disclosure.

With reference to FIG. 2, it is assumed that DQ signals (i.e., DQ[0] to DQ[7]) on multiple DQ pins are not aligned with each other before the read DQ training or the write DQ training is performed. Nonetheless, after the read DQ training or the write DQ training is performed, by changing the delay amount of DQ signals on at least some DQ pins, the DQ signals (i.e., DQ[0] to DQ[7]) on these DQ pins are aligned with each other and data signals may be transferred based on the same DQ window.

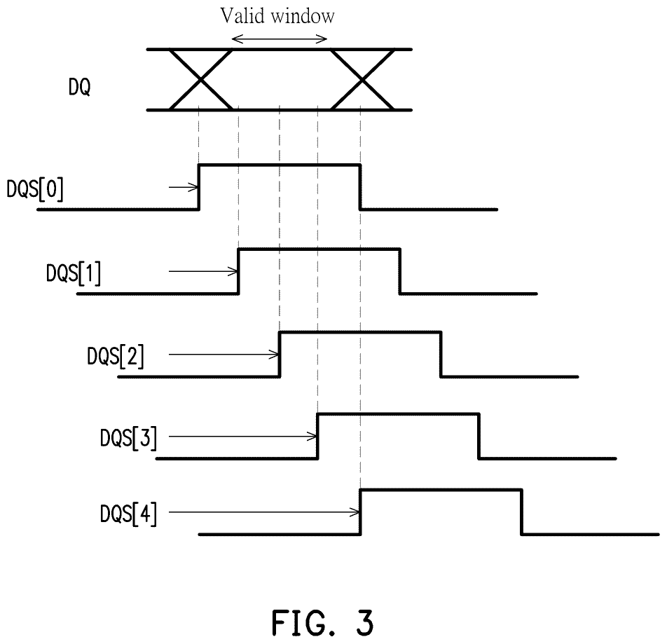

FIG. 3 is a schematic diagram of a read scan window correction and a write scan window correction according to an exemplary embodiment of the disclosure.

With reference to FIG. 3, after the read DQ training and/or the write DQ training is completed, the eye pattern in the corrected DQ signal may have a valid window. During the read scan window correction and/or the write scan window correction, the delay amount of the DQS signal may be corrected to optimize the sampling result of the DQS signal to the DQ signal.

Taking FIG. 3 as an example, multiple DQS signals (i.e., DQS[0] to DQS[4]) corresponding to different delay amounts may be sequentially generated and serve to sample the DQ signals. According to the sampling result, it can be known that the delay amount corresponding to DQS[2] is the optimal delay amount of the DQS signals.

In an exemplary embodiment, by writing test data into the rewritable non-volatile memory module 12 with a low-speed clock and reading the test data with a high-speed clock, it is possible to determine the optimal read window size for the DQ signal when data read is performed on the rewritable non-volatile memory module 12. In addition, after the read window size is set, by writing data to the rewritable non-volatile memory module 12 with a high-speed clock and reading the data through DQS signals with different delay amounts, it is possible to obtain the optimal write window size for the DQ signal.

It should be noted that the above operation details of each stage during the scan window correction are only examples, and are not intended to limit the disclosure. In addition, the above operation details of each stage during the scan window correction may also be adjusted depending on practical requirements.

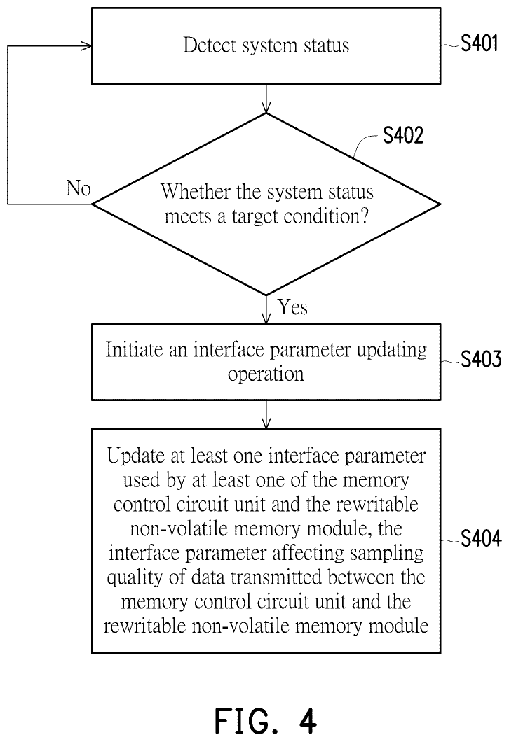

FIG. 4 is a flowchart of a parameter updating method according to an exemplary embodiment of the disclosure.

With reference to FIG. 4, in step S401, system status is detected. In step S402, whether the system status meets a target condition is determined. If the system status does not meet the target condition, step S401 may be performed repeatedly. If the system status meets the target condition, in step S403, an interface parameter updating operation is activated. In step S404, at least one interface parameter used by at least one of a memory control circuit unit and a rewritable non-volatile memory module is updated during the interface parameter updating operation, and the interface parameter affects sampling quality of data transmitted between the memory control circuit unit and the rewritable non-volatile memory module.

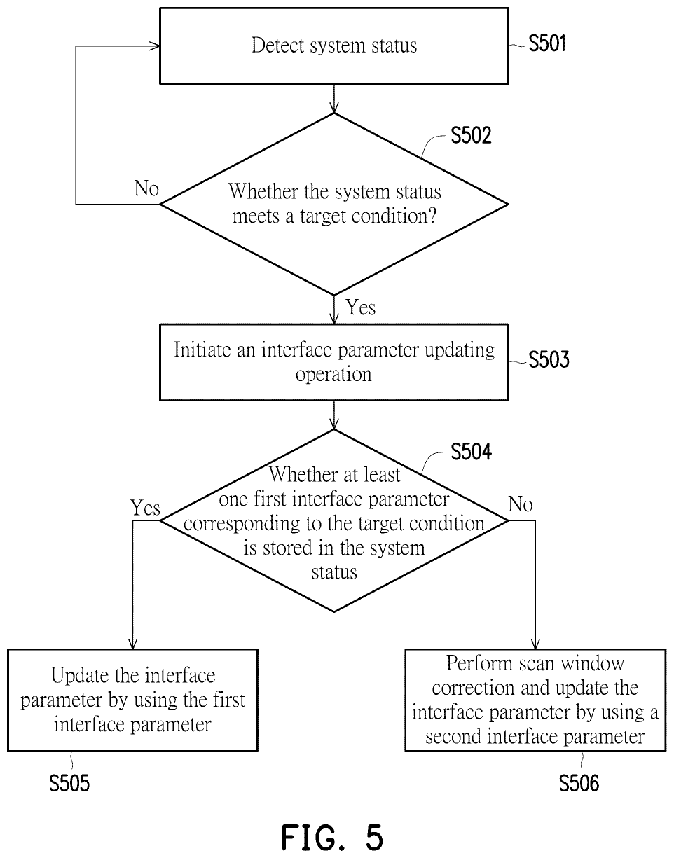

FIG. 5 is a flowchart of a parameter updating method according to an exemplary embodiment of the disclosure.

With reference to FIG. 5, in step S501, system status is detected. In step S502, whether the system status meets a target condition is determined. If the system status does not meet the target condition, step S501 may be performed repeatedly. If the system status meets the target condition, in step S503, an interface parameter updating operation is activated. In step S504, whether at least one first interface parameter corresponding to the target condition has been stored in system information is determined. If the first interface parameter corresponding to the target condition has been stored in the system information, in step S505, the interface parameter is updated by directly using the first interface parameter. Comparatively, if the first interface parameter corresponding to the target condition is not stored in the system information, in step S506, a scan window correction is performed and the interface parameter is updated by using a second interface parameter according to a correction result.

Nonetheless, each step in FIG. 4 and FIG. 5 has been described in detail above, and will not be repeatedly described here. It is worth noting that each step in FIG. 4 and FIG. 5 may be practiced into multiple programming codes or circuits, which is not limited by the disclosure. In addition, the methods of FIG. 4 and FIG. 5 may be used with the above exemplary embodiments, or may be used alone, which is not limited by the disclosure.

In summary of the foregoing, in the memory control circuit unit, the memory storage device, and the parameter updating method according to the embodiments of the disclosure, one interface parameter updating operation may be automatically activated when the current system status of the memory storage device meets one target condition. The interface parameter updating operation may automatically update the interface parameter used by the memory interface and/or the rewritable non-volatile memory module to improve or optimize the sampling quality of data subsequently transmitted between the memory interface and the rewritable non-volatile memory module. Once the sampling quality of data transmitted between the memory interface and the rewritable non-volatile memory module is improved or optimized, the overall operation performance of the memory storage device may also be improved correspondingly.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory control circuit unit configured to control a rewritable non-volatile memory module, the memory control circuit unit comprising:
a host interface configured to be coupled to a host system;
a memory interface configured to be coupled to the rewritable non-volatile memory module; and
a memory management circuit coupled to the host interface and the memory interface,
wherein the memory management circuit is configured to:
detect system status;
activate an interface parameter updating operation in response to the system status meeting a target condition; and
update at least one interface parameter used by at least one of the memory interface and the rewritable non-volatile memory module during the interface parameter updating operation, wherein the at least one interface parameter affects sampling quality of data transmitted between the memory interface and the rewritable non-volatile memory module.

2. The memory control circuit unit according to claim 1, wherein the system status reflects at least one of error status of data read from the rewritable non-volatile memory module, clock status of the memory control circuit unit, system temperature status, and data storage status of the rewritable non-volatile memory module.

3. The memory control circuit unit according to claim 2, wherein the memory management circuit is further configured to:
determine that the system status meets the target condition in response to at least one of a bit error rate of the data read from the rewritable non-volatile memory module exceeding a first threshold, the total number of error bits included in the data read from the rewritable non-volatile memory module exceeding a second threshold, the data read from the rewritable non-volatile memory module including an uncorrectable error, a clock frequency of the memory control circuit unit changing, system temperature changing, and a data storage amount of the rewritable non-volatile memory module reaching a third threshold.

4. The memory control circuit unit according to claim 1, wherein the at least one interface parameter further affects at least one of a delay amount of a DQ signal transmitted between the memory interface and the rewritable non-volatile memory module, a delay amount of a DQS signal transmitted between the memory interface and the rewritable non-volatile memory module, a read window size of the DQ signal, and a write window size of the DQ signal.

5. The memory control circuit unit according to claim 1, wherein the operation of the memory management circuit updating the at least one interface parameter used by at least one of the memory interface and the rewritable non-volatile memory module comprises:
updating the at least one interface parameter by using at least one first interface parameter corresponding to the target condition in response to the at least one first interface parameter being stored in system information.

6. The memory control circuit unit according to claim 5, wherein the operation of the memory management circuit updating the at least one interface parameter used by at least one of the memory interface and the rewritable non-volatile memory module further comprises:
performing a scan window correction between the memory interface and the rewritable non-volatile memory module in response to the at least one first interface parameter corresponding to the target condition not being stored in the system information; and
updating the at least one interface parameter by using at least one second interface parameter according to a correction result.

7. The memory control circuit unit according to claim 6, wherein the scan window correction comprises at least one of a duty cycle correction, read DQ training, write DQ training, a read scan window correction, and a write scan window correction.

8. A memory storage device comprising:
a rewritable non-volatile memory module; and
a memory control circuit unit coupled to the rewritable non-volatile memory module,
wherein the memory control circuit unit is configured to:
detect system status;
activate an interface parameter updating operation in response to the system status meeting a target condition; and
update at least one interface parameter used by at least one of the memory control circuit unit and the rewritable non-volatile memory module during the interface parameter updating operation, wherein the at least one interface parameter affects sampling quality of data transmitted between the memory control circuit unit and the rewritable non-volatile memory module.

9. The memory storage device according to claim 8, wherein the system status reflects at least one of error status of data read from the rewritable non-volatile memory module, clock status of the memory control circuit unit, system temperature status, and data storage status of the rewritable non-volatile memory module.

10. The memory storage device according to claim 9, wherein the memory control circuit unit is further configured to:
determine that the system status meets the target condition in response to at least one of a bit error rate of the data read from the rewritable non-volatile memory module exceeding a first threshold, the total number of error bits included in the data read from the rewritable non-volatile memory module exceeding a second threshold, the data read from the rewritable non-volatile memory module including an uncorrectable error, a clock frequency of the memory control circuit unit changing, system temperature changing, and a data storage amount of the rewritable non-volatile memory module reaching a third threshold.

11. The memory storage device according to claim 8, wherein the at least one interface parameter further affects at least one of a delay amount of a DQ signal transmitted between the memory control circuit unit and the rewritable non-volatile memory module, a delay amount of a DQS signal transmitted between the memory control circuit unit and the rewritable non-volatile memory module, a read window size of the DQ signal, and a write window size of the DQ signal.

12. The memory storage device according to claim 8, wherein the operation of the memory control circuit unit updating the at least one interface parameter used by at least one of the memory control circuit unit and the rewritable non-volatile memory module comprises:
updating the at least one interface parameter by using at least one first interface parameter corresponding to the target condition in response to the at least one first interface parameter being stored in system information.

13. The memory storage device according to claim 12, wherein the operation of the memory control circuit unit updating the at least one interface parameter used by at least one of the memory control circuit unit and the rewritable non-volatile memory module further comprises:
performing a scan window correction between the memory control circuit unit and the rewritable non-volatile memory module in response to the at least one first interface parameter corresponding to the target condition not being stored in the system information; and
updating the at least one interface parameter by using at least one second interface parameter according to a correction result.

14. The memory storage device according to claim 13, wherein the scan window correction comprises at least one of a duty cycle correction, read DQ training, write DQ training, a read scan window correction, and a write scan window correction.

15. A parameter updating method for a memory control circuit unit, wherein the memory control circuit unit is configured to control a rewritable non-volatile memory module, and the parameter updating method comprises:
detecting system status;
activating an interface parameter updating operation in response to the system status meeting a target condition; and
updating at least one interface parameter used by at least one of the memory control circuit unit and the rewritable non-volatile memory module during the interface parameter updating operation, wherein the at least one interface parameter affects sampling quality of data transmitted between the memory control circuit unit and the rewritable non-volatile memory module.

16. The parameter updating method according to claim 15, wherein the system status reflects at least one of error status of data read from the rewritable non-volatile memory module, clock status of the memory control circuit unit, system temperature status, and data storage status of the rewritable non-volatile memory module.

17. The parameter updating method according to claim 16, further comprising:
determining that the system status meets the target condition in response to at least one of a bit error rate of the data read from the rewritable non-volatile memory module exceeding a first threshold, the total number of error bits included in the data read from the rewritable non-volatile memory module exceeding a second threshold, the data read from the rewritable non-volatile memory module including an uncorrectable error, a clock frequency of the memory control circuit unit changing, system temperature changing, and a data storage amount of the rewritable non-volatile memory module reaching a third threshold.

18. The parameter updating method according to claim 15, wherein the at least one interface parameter further affects at least one of a delay amount of a DQ signal transmitted between the memory control circuit unit and the rewritable non-volatile memory module, a delay amount of a DQS signal transmitted between the memory control circuit unit and the rewritable non-volatile memory module, a read window size of the DQ signal, and a write window size of the DQ signal.

19. The parameter updating method according to claim 15, wherein updating the at least one interface parameter used by at least one of the memory control circuit unit and the rewritable non-volatile memory module comprises:
updating the at least one interface parameter by using at least one first interface parameter corresponding to the target condition in response to the at least one first interface parameter being stored in system information.

20. The parameter updating method according to claim 19, wherein updating the at least one interface parameter used by at least one of the memory control circuit unit and the rewritable non-volatile memory module further comprises:
performing a scan window correction between the memory control circuit unit and the rewritable non-volatile memory module in response to the at least one first interface parameter corresponding to the target condition not being stored in the system information; and
updating the at least one interface parameter by using at least one second interface parameter according to a correction result.

21. The parameter updating method according to claim 20, wherein the scan window correction comprises at least one of a duty cycle correction, read DQ training, write DQ training, a read scan window correction, and a write scan window correction.
